(19) United States
(12) Patent Application Publication
(10) Pub. No.: US 2003/0226806 A1
(43) Pub. Date: Dec. 11, 2003

(54) Methods and devices for liquid extraction

(76) Inventors: Lincoln C. Young, Ithaca, NY (US); Peng Zhou, Newton, PA (US); Michael D. Pinnisi, Ithaca, NY (US); Ronald E. Marusak, Ithaca, NY (US); James E. Moon, Fairport, NY (US)

Correspondence Address: WALL MARJAMA & BILINSKI, 101 SOUTH SALINA STREET, SUITE 400, SYRACUSE, NY, 13202, US

(21) Appl. No.: 10/437,727

(22) Filed: May 13, 2003

Related U.S. Application Data
(60) Provisional application No. 60/387,829, filed on Jun. 11, 2002.
(60) Provisional application No. 60/390,235, filed on Jun. 20, 2002.

(51) Int. Cl. B01D 11/00

(52) U.S. Cl. 210/634; 210/511; 210/321.84; 216/2; 216/56; 422/70

(57) ABSTRACT

Devices for performing liquid extraction of one or more constituents from one fluid to another fluid are provided. In operation, the fluids are separated by channel structures that stabilize the interfacial boundary between the fluids allowing, for example, countercurrent flow and exchange or other flow conditions incompatible with unassisted maintenance of laminar flow. Also provided are channel structures which aid in mixing the fluids. Thin membranes may be formed using liquid extraction devices according to the invention. A process for manufacturing such devices using DRIE is described.

### CROSS REFERENCE TO RELATED APPLICATIONS

This application claims the benefit of U.S. Application No. 60/387,829, filed Jun. 11, 2002, and U.S. Application No. 60/390,235, filed Jun. 20, 2002, the disclosures of which are hereby incorporated by reference.

### FIELD OF THE INVENTION

The invention relates generally to methods and devices for fluid control and extraction using microchannels and microstructures formed within those microchannels.

### BACKGROUND OF THE INVENTION

Modem chemical and biochemical methods of analysis and synthesis often require the ability to isolate desired constituents from fluids in which these constituents are suspended or dissolved. Thus, for example, it may be desirable to separate constituents of a solution, and then to preferentially remove one or more of the constituents. In the alternative, it may be desirable to remove constituent(s) from a first solvent, and to add the constituent(s) to a second solvent. In these exemplary processes, liquid extraction, i.e., the controlled extraction of a constituent from a fluid (typically, liquid) solvent, is a primary process step.

As is well-known in the art, the amount of a constituent solute which diffuses between fluids is proportional to the contact area between the fluids, and inversely proportional to the distance between the fluids. The efficiency of a separation procedure is gauged by the time required for the immiscible components to separate.

One liquid extraction method, bulk-mixing solvent extraction, involves the preferential transfer of one or more constituents of a solution (comprising at least one solute and a primary solvent) to an immiscible, secondary solvent via diffusion. Immiscibility of the second solvent is gauged with respect to the primary solvent. Typical liquid extraction entails combining two immiscible solvents/solutions, shaking them to distribute small droplets of one in the matrix of the second, and subsequently separating them by gravity. In this method, when the solvents are mixed, there is diffusive transfer of the desired constituent solute(s) from the small droplets of the primary solvent in the mixture to the secondary solvent (or vice versa). Following separation, each of the components is then removed from the container individually and analyzed. This bulk-mixing method is inherently a batch process typically requiring many hours to complete, making it inefficient.

Microfluidic flow extraction devices, often colloquially referred to as “lab on a chip”-type devices, improve on the bulk mixing method by taking advantage of short diffusion pathways. For example, in microfluidic devices, diffusion pathways which range on the order of 1 to 500 μm result in diffusion times between 0.1 and 100 seconds—a significant improvement on the time periods involved in bulk mixing methods. Micro channels that are formed as part of the microfluidic devices, by decreasing the diffusion distance while also maintaining pathways for a continuous flow of solvents, shorten the time for desired diffusion and are therefore suitable for a sequential analysis process where the liquid extraction portion of a process is one of a series in a continuity of experiments. The continuous flow possible in microfluidic devices is in contrast to the batch process of combining, mixing, and gravity-driven separation described above. Microfluidic devices can also provide a high ratio between contact area between fluids, and bulk fluid volume, i.e., a large diffusive surface per unit fluid volume.

There have been several different attempts to create practical and efficient microfluidic devices for the purpose of carrying out solvent extraction. One approach entails employing a vertical stack of silicon wafers with micromachined channels. The channels are formed in the substrates such that when the opposing surfaces of the wafers are aligned, a single channel is formed. The first fluid flows in the upper channel and the second fluid in the lower channel. The fluids form a boundary at their interface. Diffusion occurs at an open boundary between the two immiscible fluids.

This approach, however, depends upon the laminar flow of the immiscible fluids to maintain a stable interface that facilitates the separation of the solvents. Further, the free interface between fluids is fragile, and difficult to maintain. In particular, the interface is easily disturbed by pressure fluctuations, such as those caused by pressure differentials within the channels and those caused by viscosity differences between the two solvents, differing flow rates in a parallel flow regime, or attempting a counter flow regime. Each of these pressure variations tends to cause the free interface between the fluids to deform, making the subsequent containment of each of the fluids in its respective egress channel difficult. Also, leakage of one fluid into the other's egress path can cause errors in sample detection, or contamination of downstream processes. Thus, a free interface, while allowing for efficient diffusive transfer, is an inherently weak phenomenon and difficult to control.

Another prior art approach has attempted to overcome the difficulties associated with a free interface by interposing a polymer or paper membrane between the two opposing channels. However, these prior art membranes are generally 25 to 75 μm in thickness, causing a significant increase in diffusion distance (and, thus, diffusion time) when compared to a free interface. The membrane also significantly reduces the overall area of the fluids in contact, detrimentally reducing the contact area-fluid volume ratio. These factors cause a significant decrease in diffusion efficiency.

In an attempt to address the deficiencies associated with the use of a polymer or paper membrane, one approach encourages use of a perforated foraminous sheet between the fluids. This approach however, still requires diffusion across a significant distance (on the order of 20 μm), rendering diffusion time still quite long in comparison to the free interface.

Yet another approach has attempted to stabilize the free interface between solvents flowing in a side-by-side (rather than top to bottom) channel. In this approach, fluid channels are provided in a silicon substrate. Fluids flowing through the channels converge to a meeting place, travel together, and subsequently separate. The channels are closed via an anodically bonded lid. During the time the fluids are flowing together, diffusion between the fluids occurs through a free interface. In an attempt to stabilize the interface, this approach adds a fin-like structure between the channels. However, the contact area-fluid volume ratio is reduced as a consequence of the fin (because diffusion cannot occur through the fin), reducing the diffusive efficiency of this approach. Furthermore, the use of a fin is not always optimal for providing control over a variety of fluid flow regimes.

The fin like shape of this structure in this prior art approach is a result of the manufacturing process used to create the fin structure, namely an isotropic Reactive Ion Etch (RIE). The use of isotropic RIE results in significant design and performance limitations, such as depth to feature width ratios near 1:1. The limitation on RIE aspect ratios, in the context of fluid separation microdevices, translates to a severe limitation on the attainable contact area-fluid volume ratios. Additionally, the fin structure used to stabilize the interface presents no alternatives to a single long opening between its apex and the channel lid for the length of the channel, thus providing limited (if any) control over particular sections of the interface. The fabrication method of this prior art approach, isotropic RIE, also renders it difficult to control fine feature size, thus allowing control only over fin height, channel width, and possibly the variation of the channel's cross sectional size.

In addition to the deficiencies described above, the prior art methods (whether using a membrane or a fin) are difficult to fabricate. Some methods require multiple wafer stacks. Each of the wafers in the stack must be processed to produce the required channel geometry. The creation of features in each wafer makes alignment of the wafers compulsory. This additional alignment undoubtedly produces some mismatch, resulting in unwanted flow variations. In addition, direct wafer bonding or an adhesive can be required to create the sealed stack, creating the possibility of leakage around or through a sealed membrane. Also, the addition of an adhesive to the system adds thickness and the possibility of solute contamination. Further, where membranes are involved, handling delicate, micro-dimensioned materials is cumbersome and commercially impractical in a production environment. And, as described above, the prior art also is deficient in failing to allow the creation of channel structures of various sizes and shapes, which allow for selecting the best-suited control structure(s) for any desired fluid flow.

### SUMMARY OF THE INVENTION

It is the object of this invention to provide efficient fluid separation methods and devices which overcome the disadvantages of prior art methods and devices used to separate fluids.

In one aspect of the invention, one or more channel structures (or groups of channel structures) are provided along the center of one or more microchannels, producing a multiplicity of fluid flow paths. These control structures provide a “no-slip” surface between adjacent fluids, and stabilize the interfacial boundary between each fluid.

In a further aspect of the invention, fluids and flow characteristics are selected to create a film or membrane which is deposited on channel structures located between adjacent fluids.

In yet another aspect of the invention, channel structures are provided in the actual flow path of one or more fluids involved in the extraction process, allowing for fluid mixing during flow and, if desired, localized regions of turbulence which facilitate diffusion.

In still another aspect of the invention, microdevices for fluid extraction are manufactured using Deep Reactive Ion Etching (DRIE). Such DRIE-created microdevices allow for the creation of fluid channels with aspect ratios that result in a beneficially large contact area-fluid volume ratio.

### BRIEF DESCRIPTION OF THE DRAWINGS

FIG. 1 is a top view of a fluid extraction device according to the present invention;

FIG. 2 is a cross sectional view of the fluid extraction device of FIG. 1;

FIG. 3 is a detailed view of the ingress/egress region of the fluid extraction device of FIG. 1 and FIG. 2;

FIG. 4 is a detailed view of the diffusion channel region of the fluid extraction device of FIG. 1 and FIG. 2;

FIGS. 5A, 5B, 5C, and 5D are cross sectional views of four exemplary channel structures according to the present invention;

FIG. 6A illustrates certain factors which determine the grouping of channel structures according to the invention;

FIG. 6B illustrates off-axis orientation of channel structures according to the invention;

FIG. 7 illustrates an exemplary grouping of channel structures according to the invention;

FIG. 8 illustrates parallel flow through the fluid extraction device of FIG. 1 and FIG. 2;

FIG. 9 illustrates counter flow through the fluid extraction device of FIG. 1 and FIG. 2;

FIG. 10 illustrates the use of more than two fluids in a fluid extraction device according to the invention;

FIG. 11 illustrates the formation of an in situ membrane using the fluid extraction device according to the invention;

FIG. 12 illustrates the use of additional channel structures for mixing in a fluid extraction device according to the invention.

FIGS. 13a, 13b, 13c, and 13d illustrate use of a DRIE process to fabricate a liquid extraction device according to the invention.

### DETAILED DESCRIPTION OF THE PREFERRED EMBODIMENT

It is to be understood that the invention is not limited in its application to the details of construction and arrangements of components set forth herein in the detailed description of the preferred embodiment or illustrated in the drawings. The invention is capable of other embodiments and of being practiced or being carried out in various ways.

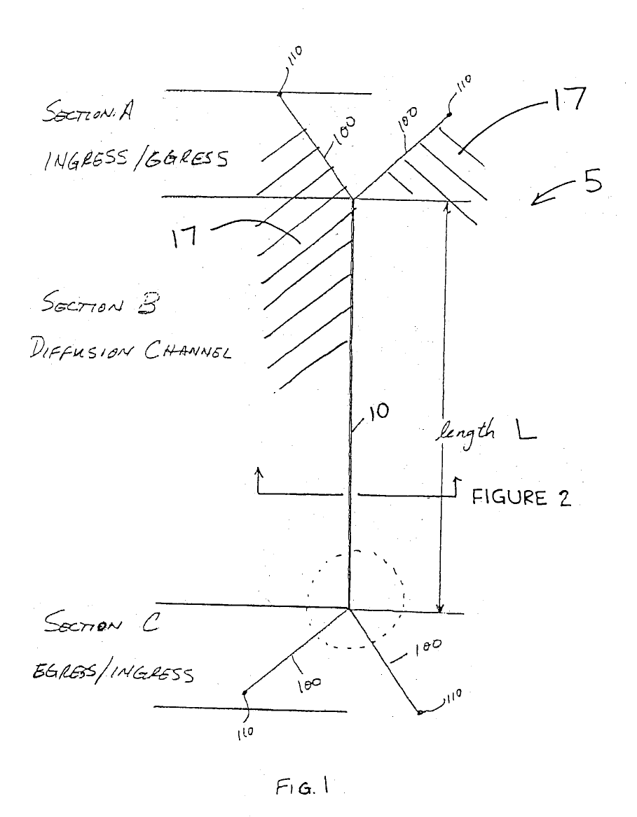

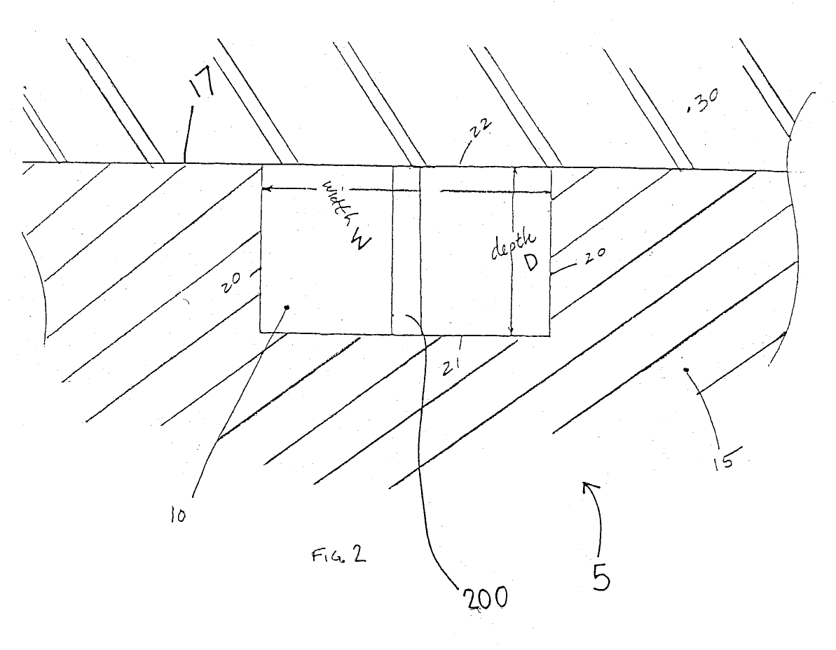

A fluid extraction device 5, according to the present invention, is illustrated in FIG. 1 and FIG. 2. The illustrative fluid extraction device 5 includes a fluid-conducting channel 10 formed in a substrate 15, through which two or more fluids flow. The fluid-conducting channel 10 also includes one or more channel structures 200, which are discussed in detail below. The substrate 15 is preferably silicon, though other materials such as glass, quartz, or plastics, could be used.

As shown in FIG. 1, the fluid-conducting channel 10 has a length L, which shown generally parallel to the direction of fluid flow through the fluid-conducting channel 10. As shown in FIG. 2, the fluid-conducting channel 10 also has a depth D (which is shown generally normal to a top surface 17 of the substrate 15) and a width W (which is shown generally parallel to the top surface 17 of the substrate 15, and perpendicular to the direction of fluid flow through the fluid-conducting channel 10). Preferably, the width D is in the range of about 1 μm to about 100 μm, and the depth is in the range of about 1 μm to about 100 μm. Channel lengths are typically less than 20 cm, though other lengths could be used if desired.

As shown in FIG. 2, the fluid-conducting channel 10 is defined on two sides by walls 20, and on a third side by a wall 21. In the illustrative embodiment, the fluid-conducting channel 10 is shown bounded on a fourth side by a lid 30. The lid 30 is shown as a separate piece which is hermetically bonded to the top surface 17 of the substrate 15. The bond between the lid 30 and the top surface 17 is preferably an anodic bond, though any other suitable bonding process, such as sodium silicate bonding, eutectic bonding, and fusion bonding, may be used. The lid 30 need not be flat, and it is contemplated that, if desired, lid 30 could be fabricated to provide a “mirror image” of the substrate 15 containing the fluid-conducting channel 10, including any channel structures formed therein (discussed below). The lid 30 also could be fabricated to include additional channel structures which function in a complementary or synergistic manner with the channel structures 200 formed in the fluid-conducting channel 10 in the substrate 15.

Further, while the fluid-conducting channel 10 is shown to have a generally rectangular cross section in FIG. 2, one skilled in the art will appreciate that any desired cross sectional shape could be selected for the fluid-conducting channel 10, subject to the limitations of the particular process chosen to fabricate the fluid-conducting channel 10. In the case of anisotropic Deep Reactive Ion Etching (discussed later), possible cross-sectional shapes include asymmetrical channels and stepped channel bottoms. Also using that method, and if desired, channels of non-uniform depth could be provided, i.e., channels in which the depth varies along the length of the channels.

In the illustrative embodiment of FIG. 1, fluids traveling through the fluid extraction device 5 move through three general sections of the fluid extraction device 5. In particular, the fluid extraction device 5 can be described as having three sections, A, B, and C. Sections A and C provide for ingress and egress to section B, where the fluid-conducting channel 10 is located (and where diffusion occurs, as described below). The ingress/egress channels 100 are in fluid communication with the fluid-conducting channel 10, and route a first fluid and a second fluid from ports 110 to the fluid-conducting channel 10. The ingress/egress channels could extend to the edges of the substrate 15 to allow for introduction of fluids into the microdevice of the present invention without requiring piercing the substrate 15 or the lid 30. The ports 110 can be provided in the substrate 15, in the lid 30, or both. Further, the ports 110 are preferably normal to the substrate surface 17. The ports 110 could also be an extension of the ingress/egress channels 100. The ports 110 could be provided with appropriate fluid connections (not shown) for the attachment of a fluid conducting mechanism, such as a capillary or reservoir, to the device.

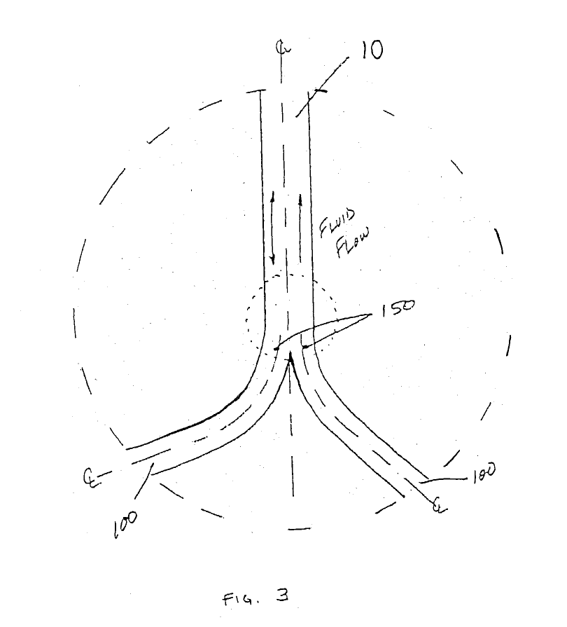

Referring to FIG. 3, the ingress/egress channels 100 preferably route fluids to the fluid-conducting channel 10 in a manner designed to promote laminar flow of fluids entering the fluid-conducting channel 10. This may be accomplished by dimensioning the ingress/egress channels 100 such that the width of each ingress/egress channel is approximately half of the width W of the fluid-conducting channel 10. The ingress/egress channels 100 are also preferably positioned and dimensioned such that fluid flow at their endpoint 150 is parallel to the length L of the fluid-conducting channel 10. The ingress/egress channels 100 also preferably are dimensioned to be the same length, to ensure a balance in fluid pressure at each endpoint 150.

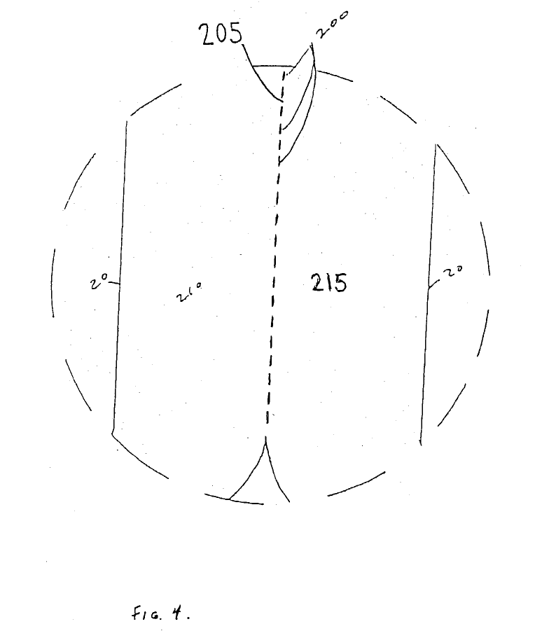

Referring to FIG. 4, and as mentioned above, a series of channel structures 200 are provided along the axis of the fluid-conducting channel 10, forming two fluid flow paths 210 and 215. In the illustrative embodiment, the flow path 210 and the flow path 215 are parallel to each other, and in close proximity. The channel structures 200 form a loose barrier between the flow path 210 and the flow path 215, and define a shared boundary between the two paths 210 and 215. The barrier formed by the channel structures 200 is termed “loose” because each of the channel structures 200 is separated from the next by a diffusion space 205. The channel structures 200 preferably extend from the wall 21 (illustrated in FIG. 2) to the lid 30 (illustrated in FIG. 2). A more detailed description of the cross sectional shapes of the channel structures 200 is provided below.

As is well known to those skilled in the art, the diffusive transfer of a constituent through an interfacial boundary is directly proportional to the area of the interfacial boundary, and inversely proportional to the thickness of the interfacial boundary. It is believed that the fluid extraction device of the present invention maximizes diffusive transfer by providing a large, no-slip interfacial boundary area, and a small interfacial boundary thickness (also referred to as diffusion distance). The present invention allows for this maximized diffusive transfer without destabilizing the interfacial boundary. A stable interfacial boundary is desired in order to maintain pressure differentials across the boundary (which arise from differences in flow velocity, viscosity, or channel dimensions between the two fluids flowing in flow paths 210 and 215). The interfacial boundary is believed to “bulge” in order to reach an equilibrium between the pressures of the two fluids flowing through flow paths 210 and 215, forming a radius of curvature between to the two fluids in the direction of the fluid having the lower pressure. The smaller the radius of curvature of the bulge, the higher the pressure differential between the two fluids.

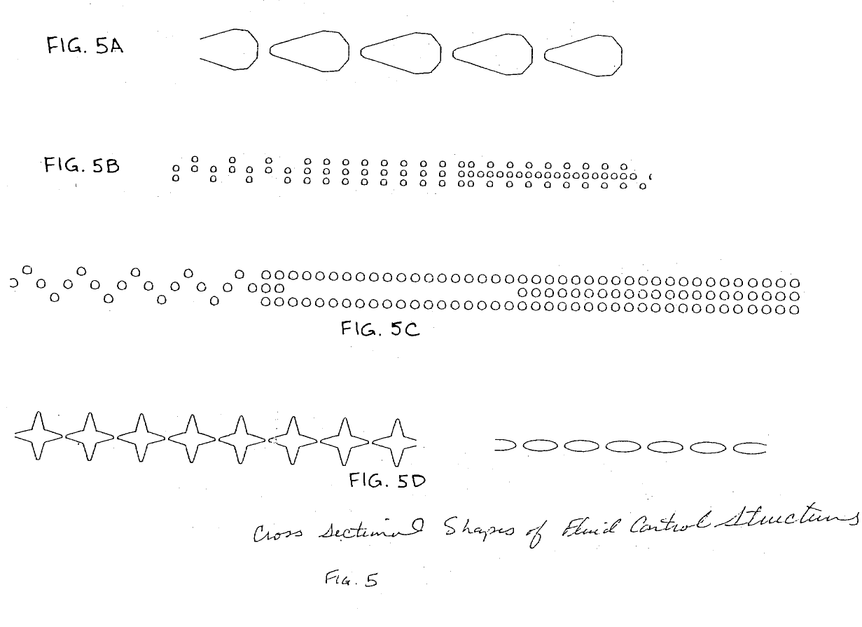

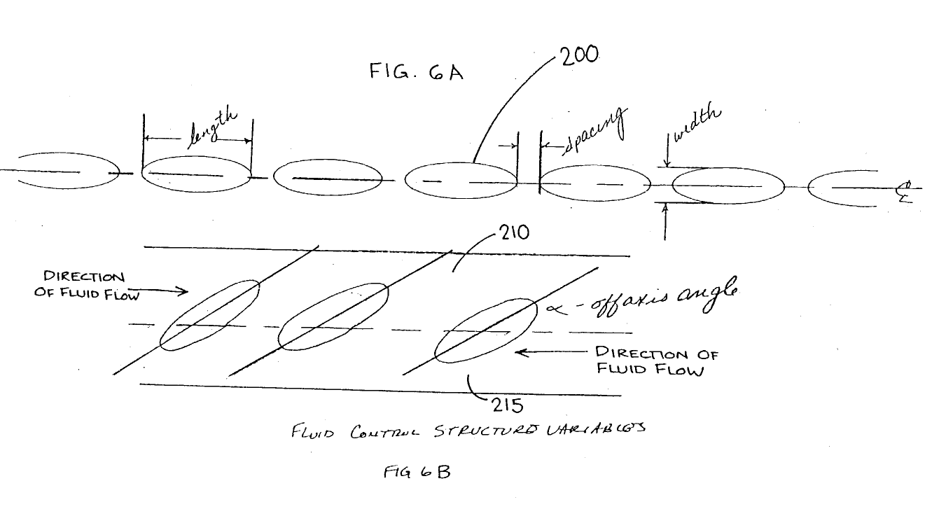

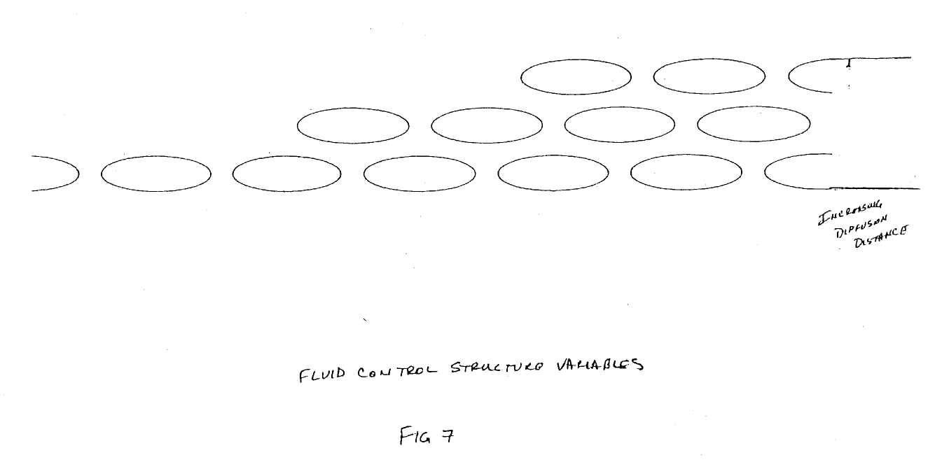

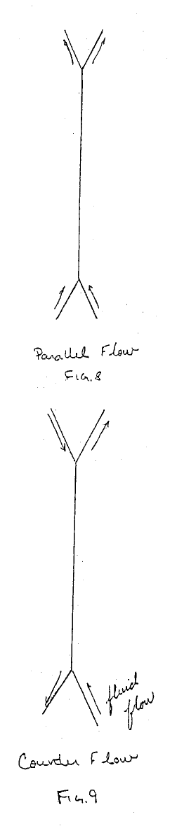

In the present invention, the interfacial boundary is supported by the channel structures 200. Further, the interfacial boundary can be controlled by varying the dimensions and shape of the channel structures 200. As shown by the illustrative shapes of FIGS. 5a through 5d, the channel structures 200 may be formed in a variety of cross sectional shapes. For example, FIG. 5A illustrates a generally teardrop shaped channel structure, FIGS. 5B and 5C illustrate circular channel structures, and FIG. 5D illustrates cross-shaped channel structures. Other cross sectional shapes of channel structures, such as squares, rectangles, ellipses, airfoils, and ogees, could be used instead. In addition, the grouping of the channel structures 200 also can be used to control the interfacial boundary. As illustrated in FIG. 6, by “grouping” what is meant is the preferential arrangement of the channel structures 200 attributable to variable spacing, width, and length of each of the channel structures 200. Further, as illustrated in FIG. 6B, the channel structures 200 also may be oriented in an off axis manner (i.e., so that a major or minor axis of the channel structures 200 is not parallel to the direction of fluid flow). As illustrated in FIG. 7, the channel structures 200 also may be layered, so that the separation between the flow path 210 and the flow path 215 at different points varies as a function of the number of channel structures 200 interposed between the two flow paths.

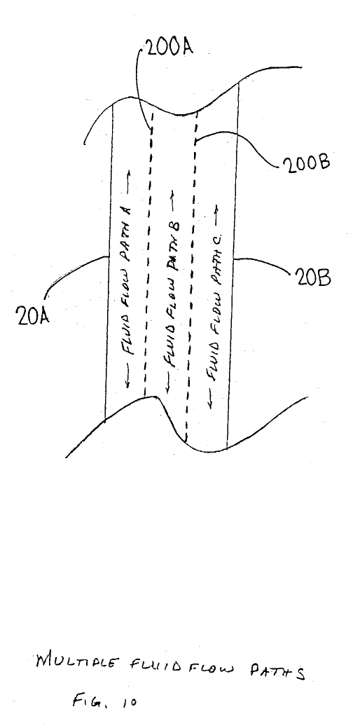

Flow through the fluid extraction device 5 may be of several varieties. For example, as illustrated in FIG. 9, fluids flowing through flow paths 210 and 215 may be moving in the same direction, creating a parallel flow regime.

In the alternative, the fluids flowing in flow paths 210 and 215 may be moving in opposite directions, creating a countercurrent flow regime. It is believed that, the off-axis channel structures 200 illustrated in FIG. 6B are especially conducive to stabilizing the interfacial boundary in a countercurrent flow regime. Specifically, it is believed that by tipping the structures away from the axis of the diffusion channel, each of the respective fluids can be directed back to its flow path. As is known to one of ordinary skill, diffusive transfer in a counter flow regime is more rapid than that in a parallel flow regime. Further, in a countercurrent flow regime, the highest pressure differentials are believed to occur at the ends of each flow channel (e.g., Sections A and C of FIG. 1), while the middle of the channel (e.g., Section B of FIG. 1) is described by a low (approximating zero) pressure differential (due to the pressure drop along the channel length). The present invention is able to account for these differences in pressure differentials by reducing the spacing between each of the channel structures 200 at the ends of the channel, and increasing the spacing between each of the channel structures 200 in the middle of the channel.

One of ordinary skill will appreciate that, since fluid extraction microdevices according to the invention are able to control the fluid interface under countercurrent flow regimes, these inventive devices also could be used to control the interface under less demanding flow regimes. Thus, the countercurrent flow arrangement also is usable, for example, to sustain the interfacial boundary when fluid in one flow path is stationary, and fluid in the other flow path is moving.

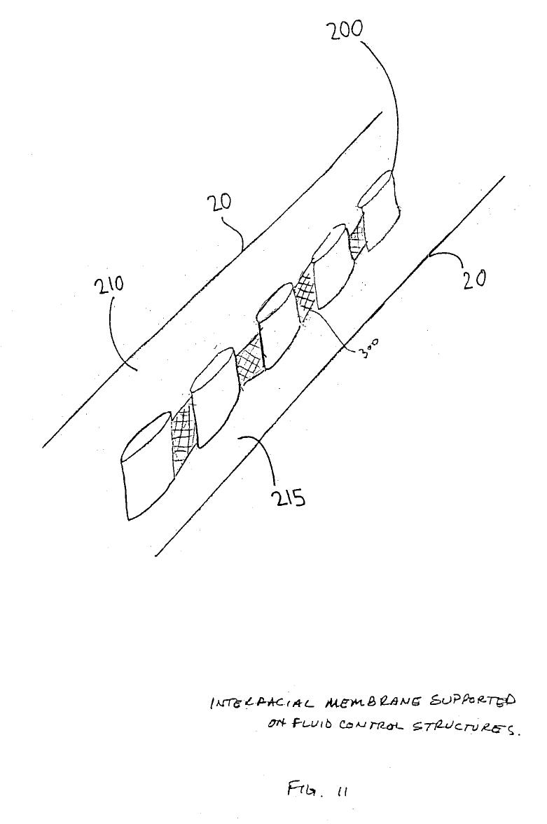

The present invention is not limited to diffusive transfer between two fluids only. As illustrated in FIG. 10, two or more fluids (three fluids in the illustration of FIG. 10) can flow through flow paths formed as part of a fluid extraction device according to the invention, where each flow path is separated by a group of channel structures (200A and 200B in FIG. 10). The illustrative embodiment of FIG. 10 is designed to allow diffusion of a constituent from fluid A to fluid C via fluid B or, in the alternative, the diffusion of a constituent from fluid B to fluids A and C. The former of the two arrangements allows the transfer from an aqueous solvent through an organic solvent to a second aqueous solvent. This would otherwise be impossible if only two flow paths were provided, as the two aqueous solvents would not make an immiscible boundary, but would simply mix. The widths of these multiple channels could be varied to allow for the most efficient solute transfer, (i.e. the width of channel B, which contains the organic solvent in the illustrative embodiment, could be very narrow compared to the aqueous fluids in channels A and C).

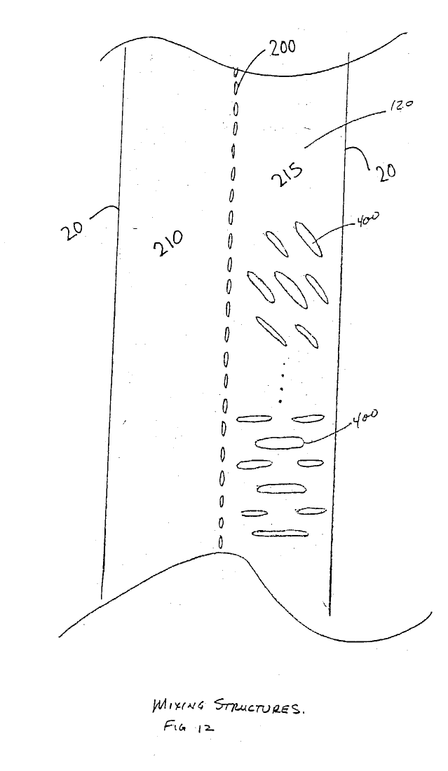

Fluid extraction devices according to the present invention also could be used to form desired membranes at the interfacial boundary, which are deposited on the channel structures. As illustrated in FIG. 11, two appropriate solvents could be flowed through flow paths 210 and 215 to form an in situ membrane 300. If a polymer membrane is desired, interfacial polymerization can occur, for example, when two immiscible fluids carrying appropriately reactive monomers (i.e. water/diamine and dichloromethane/sebacoyal chloride, if nylon is the desired membrane) are allowed to interface using the fluid extraction device of the invention. The formed membrane is supported on the channel structures 200, allowing for formation of exceedingly thin and delicate membranes (with thicknesses on the order 3-5 μm, and preferably, of 1 μm or less). These thicknesses are believed to be much less than the membrane thicknesses possible with existing membrane production technologies.

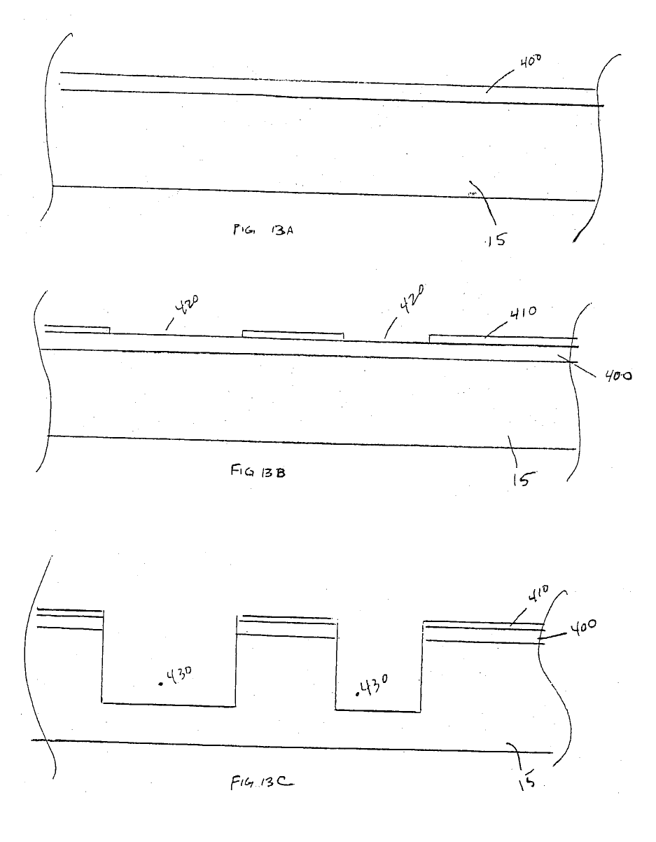

A further variation on the present invention is illustrated in FIG. 12. In FIG. 12, additional channel structures 400 are provided in the flow path 215 of a fluid. These additional channel structures 400 allow for mixing the fluid flowing through the flow path 215, to promote a more even distribution of the constituent (which is desired to be diffused into fluid of flow path 210) across the width of the flow path 215. By promoting an even distribution, the diffusion gradient with respect to the constituent near the interfacial boundary (and the channel structures 200) is believed to remain relatively constant over the length of the flow path 215.

It is preferred that fluid extraction devices according to the present invention be fabricated using fabrication methods and equipment developed for the creation of microelectromechanical (MEMS) devices. Dry etching of silicon, whether primarily physical in nature (ion-milling) or primarily chemical (plasma etching), is a highly evolved part of the overall fabrication process. Particularly preferred for formation of channel structures according to the invention are anisotropic Deep Reactive Ion Etching (DRIE) techniques. The use of DRIE allows for the production of fine features (on the order of 1 μm), while still attaining a high aspect ratio. The use of DRIE allows changing the size, shape, spacing, angle, and layer of features at any point along the length of a microdevice channel, such as the channel structures 200 in fluid conducting channel 10 in FIGS. 1 and 2. In addition to design flexibility, the use of DRIE provides small dimensional fabrication errors (about ±1% to ±10%). Further, the use of DRIE to fabricate microdevices and channel structures of the present invention allows for efficient fabrication, often with only one or two mask steps (described below). The use of DRIE also allows for imparting specific characteristics to the exposed surfaces of channels and channel structures, such as preferentially making the surfaces hydrophobic (for example, by depositing silicon nitride) or hydrophilic (for example, by providing a silicon dioxide layer).

DRIE techniques employ a combination of physical and chemical mechanisms, and are the most commonly practiced embodiment of dry etching. As described below, a particular class of silicon etch processes has been developed specifically for high-aspect-ratio etching of silicon in MEMS applications.

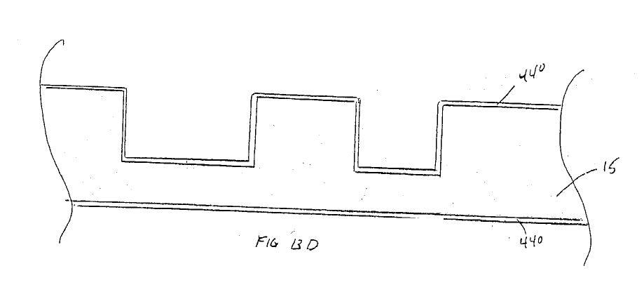

A typical DRIE process flow for the liquid extraction device is illustrated in FIGS. 13A through 13D. In FIG. 13A, a substrate 15 is provided and a suitable material 400 is grown or deposited to act as a mask for subsequent etching. This material 400 may be, for example, silicon dioxide or silicon nitride. As illustrated in FIG. 13B, a polymeric photoresist 410 is then deposited over the surface of the substrate 15 and the masking material 400. This photoresist layer 410 is patterned by exposing it preferentially through a mask to a UV light source (not shown). When developed, a copy of the mask pattern is transferred to the polymeric photoresist 410, resulting in openings in the polymeric photoresist 420. The substrate 15 is then etched to open the masking material 400 preferentially where the polymeric material is open 420. The substrate is then further etched by a DRIE process to produce deep trenches in the substrate material 430, as shown in FIG. 13C. Finally, as shown in FIG. 13D, the polymeric photoresist 410 and the masking material 400 are stripped from the substrate 15 either by plasma etching or chemical bath, and the substrate 15 is exposed to an oxidizing atmosphere in a furnace to grow a passivating layer 440 of silicon dioxide over the entire surface. In the context of the present invention, locations corresponding to the desired locations of the channel structures are not etched, thus leaving the channel structures behind when the fluid conducting channel is etched around the locations for the channel structures. Optionally, a DRIE etch can be used to control the height of the channel structures, either before or after the channel etch is performed.

There are many variations on this process which could be utilized to produce a DRIE feature. For example, the masking material 400 could be avoided, and a thicker layer of polymeric material 410 could be substituted. Additionally, the final passivation layer 440 could be avoided, or another material (i.e. silicon nitride or polysilicon or a sputtered or evaporated metal) could be substituted.

The advantages of using this type of DRIE process flow center around the ability to produce very fine features, sizes on the order of 1 μm. As the process is anisotropic, meaning the etch is strongly preferential to a particular direction, the mask is very closely reproduced in the substrate. This is not the case for most RIE processes. Very often an isotropic RIE etch process will produce an undercut of the mask, limiting the control over fine feature sizes. Additionally, the lack of anisotropy in RIE etches limits the aspect ratio of the features being etched to less than 1:10.

Thus, an anisotropic DRIE process can be used to fabricate channels for liquid extraction microdevices according to the invention, in the manner described above, in silicon substrates. The interfacial area of the device, or more specifically, the interfacial area to fluid volume ratio, is important. The larger this ratio, the more effective the transfer of solute will be, as would expected when maximizing contact area and minimizing diffusion distance with respect to interfacial contact area. DRIE is uniquely suited to the creation of these high aspect ratios, being able to attain aspect ratios (depth of feature to feature width) of 50:1 or more, ten or more times that of other dry etch (RIE) processes, and 50 or more times that of isotropic RIE.

While the invention has been described in conjunction with a preferred embodiment, it is evident that numerous alternatives, variations, and modifications will be apparent to those skilled in the art in light of the foregoing description. Thus, it is understood that the invention is not to be limited by the foregoing illustrative details.

### Equivalents

While the invention has been particularly shown and described with reference to specific embodiments, it should be understood by those skilled in the art that various changes in form and detail may be made therein without departing from the spirit and scope of the invention as defined by the appended claims.

What is claimed is:

1. A device for separating at least one constituent from a first fluid by allowing for the at least one constituent to diffuse into a second fluid, where the first fluid and the second fluid are immiscible with respect to one another and form an interfacial boundary where the first fluid and the second fluid contact each other, comprising:
a substrate in which at least one channel is defined; and
a first plurality of channel structures in each channel defining a first flow path through which the first fluid flows and a second flow path through which the second fluid flows,
such that the at least one constituent diffuses from the first fluid to the second fluid at least in part through the first plurality of channel structures.

2. The device of claim 1, wherein the first plurality of channel structures stabilizes the interfacial boundary between the first fluid and the second fluid.

3. The device of claim 1, further comprising a second plurality of channel structures formed in the first flow path.

4. The device of claim 1, wherein the channel is defined using Deep Reactive Ion Etching (DRIE) methods.

5. The device of claim 1, wherein the first plurality of channel structures is formed using Deep Reactive Ion Etching (DRIE) methods.

6. The device of claim 5, wherein the first plurality of channel structures has an aspect ratio of at least about 50:1.

7. The device of claim 1, wherein the substrate is selected from the group of substrates consisting of: silicon, glass, quartz, and plastic.

8. The device of claim 1, wherein the first fluid and the second fluid are selected so that a membrane is deposited on the first plurality of channel structures when the first fluid and the second fluid contact one another.

9. The device of claim 8, wherein the thickness of the membrane is less than about 5 μm.

10. The device of claim 9, wherein the thickness of the membrane is less than about 3 μm.

11. The device of claim 10, wherein the thickness of the membrane is less than about 1 μm.

12. The device of claim 1, wherein the first plurality of channel structures is arranged in layers.

13. The device of claim 1, wherein each of the first plurality of channel structures has a cross-sectional shape selected from the group of cross-sectional shapes consisting of: circle, square, rectangle, teardrop, ellipse, cross, airfoil, and ogee.

14. The device of claim 1, wherein the first plurality of channel structures is oriented in an off-axis manner with respect to the first flow path and the second flow path.

15. The device of claim 1, wherein the first fluid and the second fluid flow in a parallel flow regime.

16. The device of claim 1, wherein the first fluid and the second fluid flow in a countercurrent flow regime.

17. The device of claim 1, wherein the depth of the channel is in the range of about 1 μm to about 100 μm.

18. The device of claim 1, wherein the width of the channel is in the range of about 1 μm to about 100 μm.

19. The device of claim 1, wherein the length of the channel is less than 20 cm.

20. The device of claim 1, wherein the channel is asymmetrical.

21. The device of claim 1, wherein a bottom of the channel is stepped.

22. The device of claim 1, wherein the depth of the channel is non-uniform.

23. A method for fabricating a liquid extraction device, comprising the steps of:
providing a substrate;
determining a plurality of locations on the substrate corresponding to the location of a plurality of channel structures of desired cross-sectional shape and configuration; and
performing anisotropic Deep Reactive Ion Etching (DRIE) to define a channel of desired length, depth, and width in the substrate around the plurality of channel structures.

24. The method of claim 23, further comprising the step of altering the height of at least one of the plurality of channel structures after the channel is defined.

25. The method of claim 23, further comprising the step of altering the height of at least one of the plurality of channel structures before the channel is defined.

26. The method of claim 23, wherein the desired length of the channel is less than 20 cm.

27. The method of claim 23, wherein the desired depth of the channel is in the range of about 1 μm to about 100 μm.

28. The method of claim 23, wherein the desired width of the channel is in the range of about 1 μm to about 100 μm.

29. The method of claim 23, wherein the desired cross-sectional shape of the plurality of channel structures is chosen from the group of cross-sectional shapes consisting of: circle, square, rectangle, teardrop, ellipse, cross, airfoil, and ogee.

30. The method of claim 23, further comprising the step of providing a lid on the substrate after the channel is defined.

31. The method of claim 30, further comprising the step of bonding the lid to the substrate.

32. The method of claim 31, wherein the step of bonding is accomplished using a bonding method selected from the group of bonding methods consisting of: anodic bonding, sodium silicate bonding, eutectic bonding, and fusion bonding.

33. The method of claim 31, wherein after the channel is defined, the plurality of channel structures has an aspect ratio of at least about 50:1.

34. A method of controlling the size of an interfacial boundary in a liquid extraction microdevice, comprising the steps of:
providing a fluid-conducting conduit of a predetermined depth; and
providing a plurality of spaced apart channel structures in said fluid-conducting conduit, wherein the length and width of each of said plurality of channel structures can be controlled, and the spacing between each of said plurality of channel structures can be controlled,
wherein the size of the interfacial boundary varies with said predetermined depth, said length, said width, and said spacing.

35. A method of fabricating a membrane, comprising the steps of:
providing a substrate having a channel defined therein, and a plurality of channel structures in the channel, said plurality of channel structures defining a first flow path and a second flow path;
selecting a first liquid and a second liquid which, when combined, form the membrane;
flowing the first liquid through the first flow path and a second liquid through the second flow path, such that a membrane forms on at least a portion of said plurality of channel structures.

36. The method of claim 35, wherein the formed membrane has a thickness in the range of about 3 μm to about 5 μm.

37. A liquid extraction system, comprising:
a substrate defining a channel;
a first plurality of spaced-apart channel structures in said channel defining a first flow path and a second flow path;
at least one ingress port in fluid communication with the channel, and at least one egress port in fluid communication with the channel; and
a lid enclosing the channel.

38. The liquid extraction system of claim 37, wherein the aspect ratio of at least one of the plurality of channel structures is at about 50:1 or greater.

39. The liquid extraction system of claim 37, wherein the channel is defined in the substrate using anisotropic Deep Reactive Ion Etching (DRIE) techniques.

40. The liquid extraction system of claim 37, wherein the lid defines a channel complementary to the channel defined in the substrate.

41. The liquid extraction system of claim 37, wherein the lid includes a second plurality of channel structures.

42. The liquid extraction system of claim 37, further comprising a second plurality of channel structures in at least one of said first flow path and second flow path.
